(19) United States
(12) Patent Application Publication
(10) Pub. No.: US 2024/0233775 A1
(43) Pub. Date: Jul. 11, 2024

(54) AUGMENTED PERFORMANCE REPLACEMENT IN A SHORT-FORM VIDEO

(71) Applicant: Loop Now Technologies, Inc., San Mateo, CA (US)

(72) Inventors: Wu-Hsi Li, Somerville, MA (US); Edwin Chiu, Cupertino, CA (US); Jerry Ting Kwan Luk, Menlo Park, CA (US); Hong-Ming Tseng, Toronto (CA); Jeremiah Kevin Tu, Sunnyvale, CA (US); Ziming Zhuang, Palo Alto, CA (US)

(73) Assignee: Loop Now Technologies, Inc., San Mateo, CA (US)

(21) Appl. No.: 18/407,560

(22) Filed: Jan. 9, 2024

Related U.S. Application Data
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.

(51) Int. Cl. G11B 27/036; H04N 21/2187; H04N 21/478; H04N 21/4788; H04N 21/81; H04N 21/85

(52) U.S. Cl. CPC G11B 27/036; H04N 21/2187; H04N 21/47815; H04N 21/4788; H04N 21/81; H04N 21/85

(57) ABSTRACT

Disclosed embodiments provide techniques for augmented performance replacement in a short-form video. A short-form video is accessed, including a performance by a first individual. Using one or more processors, the performance of the first individual is isolated. Specific elements of the performance including gestures, clothing, expressions, and accessories are included in the isolation process. An image of a second individual is retrieved and information on the second individual is extracted from the image. A second short-form video is created by replacing the performance of the first individual with the second individual. The second short-form video is augmented based on viewer interaction. The augmenting of the second short-form video occurs dynamically. The augmenting includes additional audio content based on comments, responses to live polls or surveys, or questions and answers from viewers. The augmenting includes switching audio content in the second short-form video with additional audio content.

### RELATED APPLICATIONS

This application claims the benefit of U.S. provisional patent applications “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video analysis and more particularly to augmented performance replacement in a short-form video.

### BACKGROUND

Visual arts, such as painting and drawing, have been part of the culture since human civilizations began. Many of our oldest historical artifacts are drawings made with sticks, stones, and other primitive objects. Some drawings date back to 10,000 BC. Our desire to record events and communicate history or fiction about people, places, and ideas continues to drive us to use visual arts in creative ways. Painting and drawing on pottery dates back as early as 480 BC in parts of China. Combining pictures with the written word became commonplace in many parts of the world nearly as soon as written alphabets were developed. As materials for more refined drawing and painting became available, more varied and sophisticated forms of visual arts arose. Various forms of watercolors were used as early as 4,000 BC. By the 4th century AD, landscapes in watercolors were widely produced. Painting with colored oils dates back as far as the 7^{th} century AD; oil painting became widely practiced in the 15^{th} century. Colored pencils, chalk, crayons, and charcoal are used with a wide variety of mediums to depict images and written messages using forms such as cartoons and caricatures, simple or complex figure and gesture drawing, pointillism, and photorealism.

Visual arts have expanded in the use of combined forms as well. Artists link visual pieces with music, spoken words, or other recorded sounds. Motion pictures, television, and videos have become important avenues that we use to express ourselves, inform, instruct, entertain, persuade, buy, and sell. Professionals and amateurs now produce motion pictures and videos at a phenomenal rate and in increasingly sophisticated ways. Computers can be used to draw images with colors and textures simultaneously. Motion pictures are made using both film and digital recording. Animation has grown from single-pane cartoons to three-dimensional images which are nearly indistinguishable from real life. Pieces of art that were once available only in a museum can now be viewed anywhere, at any time. Their images can be manipulated using software available on a home computer or cell phone. Photographs and videos can be quickly taken and edited on handheld devices and distributed via social media platforms within minutes of being produced.

As the various forms of producing and refining informational and artistic content have grown, so have the methods implemented to preserve, store, and categorize the content for future study as well as immediate use. Networks of storage devices and increasingly powerful systems to manage and maintain data have grown across nations and continents in order to satisfy requirements of governments, multi-national conglomerates, and everyday individual users. Individuals shoot videos using cell phones or tablets for all sorts of reasons: to remember a special event or place, to demonstrate the latest dance craze, to play songs or recite poetry, to teach, to share, to laugh, or to grieve. Billions of people actively use social media and routinely include digital pictures and recorded videos in everyday communication. In social media systems and other content sharing systems, video, music, and other media files are encoded and transmitted in sequential packets of data so they can be streamed instantaneously. Photos, sound bites, and short-form videos produced worldwide expand our perception immeasurably. Our continued desire to link sight and sound in ways that can excite, inform, persuade, entertain, and communicate more effectively has not abated since humanity began, and it shows no sign of slowing in our future.

### SUMMARY

Short-form videos are a growing an increasingly important means of communication in education, art, government, and business. As messages using short-form videos become more sophisticated, the audiences, including potential buyers of goods and services, are becoming increasingly selective in their choices of message content, means of delivery, and deliverers of messages. Finding the best spokesperson for a short-form video can be a critical component to the success of marketing a product. Ecommerce consumers can discover and be influenced to purchase products or services based on recommendations from friends, peers, and trusted sources (like influencers) on various social networks. This discovery and influence can take place via posts from influencers and tastemakers, as well as friends and other connections within the social media systems. In many cases, influencers are paid for their efforts by website owners or advertising groups. The development of effective short-form videos in the promotion of goods and services is often a collaboration of professionally designed scripts and visual presentations distributed along with influencer and tastemaker content in various forms. Commercial presentations, such as livestream events, can be used to combine pre-recorded, designed content with viewers and hosts. These collaborative events can be used to promote products and gather comments and opinions from viewers at the same time. Operators behind the scenes can respond to viewers in real time, engaging the viewers and increasing the sales opportunities. By harnessing the power of machine learning and artificial intelligence (AI), media assets can be used to inform and promote products using the images and voices of influencers best suited to the viewing audience. Using the techniques of disclosed embodiments, it is possible to create effective and engaging content in real time collaborative events.

Disclosed embodiments provide techniques for augmented performance replacement in a short-form video. A short-form video is accessed, including a performance by a first individual. Using one or more processors, the performance of the first individual is isolated. Specific elements of the performance including gestures, clothing, expressions, and accessories are included in the isolation process. An image of a second individual is retrieved and information on the second individual is extracted from the image. A second short-form video is created by replacing the performance of the first individual with the second individual. The second short-form video is augmented based on viewer interaction. The augmenting of the second short-form video occurs dynamically. The augmenting includes additional audio content based on comments, responses to live polls or surveys, or questions and answers from viewers. The augmenting includes switching audio content in the second short-form video with additional audio content.

A computer-implemented method for video processing is disclosed comprising: accessing a short-form video, wherein the short-form video includes a performance by a first individual; isolating, using one or more processors, the performance by the first individual from within the short-form video; retrieving an image, wherein the image includes a representation of a second individual; extracting information on the second individual from the image; creating a second short-form video by replacing the performance by the first individual, that was isolated, with the second individual, wherein the replacing is accomplished by machine learning; rendering the second short-form video; and augmenting the second short-form video, wherein the augmenting is based on viewer interactions, and wherein the augmenting occurs dynamically. Some embodiments comprise switching audio content in the second short-form video with additional audio content, wherein the additional audio content matches a voice of the second individual. And some embodiments comprise adding additional audio content to the second short-form video, wherein the additional audio content matches a voice of the second individual.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for augmented performance replacement in a short-form video.

FIG. 2 is a flow diagram for augmenting a short-form video with an ecommerce purchase.

FIG. 3 is an infographic for augmented performance replacement in a short-form video.

FIG. 4 is an infographic for switching audio content by an operator.

FIG. 5 is an infographic for adding audio content based on viewer comments.

FIG. 6 is an infographic for augmenting content in a livestream.

FIG. 7 is an infographic for applying attributes of the first individual.

FIG. 8 is an infographic for changing attributes of the second individual.

FIG. 9 shows an ecommerce purchase implementation within a short-form video environment.

FIG. 10 is a system diagram for augmented performance replacement in a short-form video.

### DETAILED DESCRIPTION

Generating effective short-form video content can be a long and complex process. Many short-form videos require multiple rounds of recording and editing video and audio content, writing and rewriting texts, and so on before an acceptable version is completed. Selecting the right narrator or host to be the spokesperson can be a critical component in the success of short-form videos, particularly in product promotions. Getting the right person can lead to increased market share and revenue.

Video events such as livestreams can be an effective way of engaging customers and promoting products. Short-form videos can form the foundation of livestream events, and can be combined with operators and libraries of pre-recorded or real time comments and responses to viewer interactions. Artificial intelligence (AI) machine learning platforms can enable short-form videos to be used with voices and images of influencers and spokespersons in real time, so that livestream events can be combinations of produced content, viewer interactions, and dynamic host presentations.

Techniques for video analysis are disclosed. A short-form video that includes a performance by a first individual can be accessed or produced. The performance of the first individual can be analyzed so that various attributes such as facial features, gestures, articles of clothing, expressions, and so on are isolated and stored as interchangeable, replaceable elements. Still photographs and video images of a second individual can be analyzed, separated into various elements, and stored in the same manner. Through the use of a machine learning artificial intelligence (AI) network, the performance of the first individual in the short-form video can be replaced with the face and features of the second individual. Using a similar machine learning network, the voice of the first individual can be replaced with the voice of the second individual, so that the entire performance of the first individual in the short-form video is delivered by the second individual. A second short-form video featuring the second individual can be recorded for later viewing or rendered directly to a viewing audience. Additional features such as alternate clothing, facial expressions, gestures, background images, accessories, and products for sale can be included in the second short-form video to augment the performance of the second individual.

The second short-form video can form the basis of a livestream event. An operator can work behind the scenes of the livestream as it occurs, combining the short-form video with responses to viewer comments and questions, chats, purchases, and so on. Responses to viewers can come from pre-recorded libraries of audio and video comments or real time comments made by the first individual, and can be swapped with the image and voice of the second individual. The result is a livestream event that is more engaging for the viewer and hosted by individuals more likely to deliver higher sales and market share.

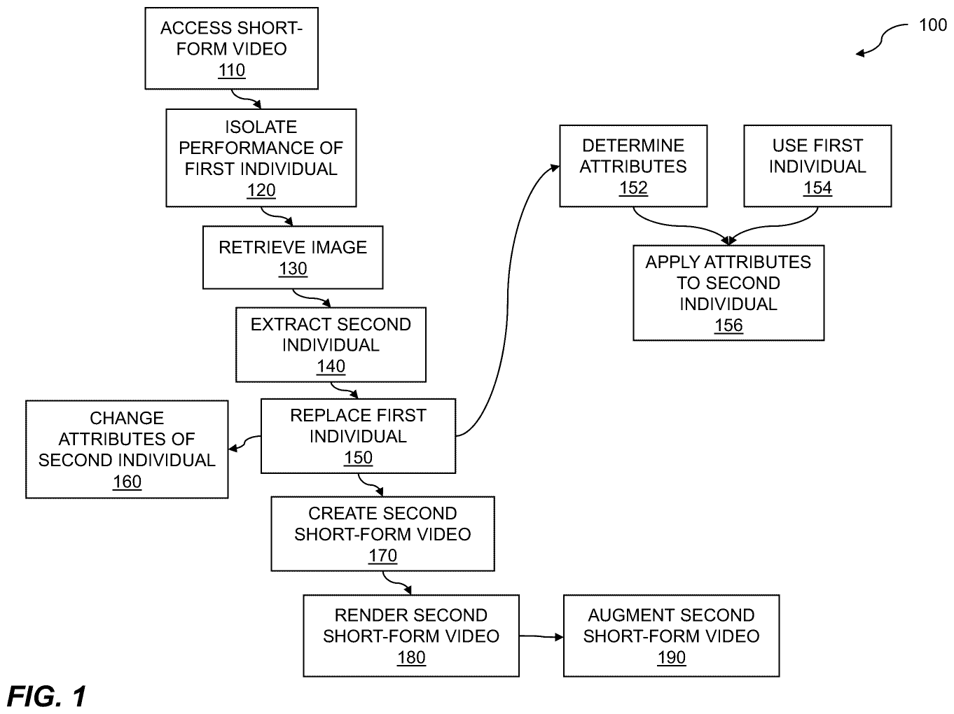

FIG. 1 is a flow diagram 100 for augmented performance replacement in a short-form video. The flow 100 includes accessing a short-form video 110. In embodiments, the short-form video can include a performance by a first individual. The first individual performance can be delivered by a human or generated by artificial intelligence. The short-form video can be used as a livestream event or a livestream playback. In some embodiments, the short-form video can highlight one or more products for sale. The flow 100 includes isolating the performance of the first individual 120 in the short-form video. In embodiments, artificial intelligence (AI) algorithms are used to detect the subject in the foreground of the video, mask the foreground image, and remove the background elements. In some embodiments, video data from the short-form video is synchronized with depth data captured by a depth sensor camera used along with the short-form video camera. A depth sensor camera, also known as a Time of Flight or ToF camera, uses pulses of laser light to create a three-dimensional map of an image, such as an individual recording a video of him- or herself. The map can be generated in real time and used to apply various effects to images and videos. The rate at which the depth sensor camera produces the three-dimensional map must be synchronized to the frame rate used by the first video camera. The video content can be used to detect the presence of an individual (or a portion thereof), or the face of an individual in the video. Face detection can be done using artificial-intelligence-based technology to locate human faces in digital images. Once AI algorithms detect a face in a digital image, additional datasets can be used to compare facial features in order to match a face located in video image with a previously stored faceprint and to complete the recognition of a particular individual. Data from a depth sensor camera can be used to determine the distance between the short-form video camera and the face of the first individual. The first depth can be combined with a predetermined cutoff depth, for example 0.25 meters, to set the maximum distance from the first camera in order to generate a binary mask. A binary mask is a digital image consisting of zero and non-zero values. In some embodiments, a binary mask can be used to filter out all digital pixel data that is determined to come from objects that are either closer or farther away from the camera than the first depth or cutoff depth. For example, a first individual with a camera facing toward the individual records a short-form video. A depth sensor camera determines that the distance from the camera to the individual's face is 0.75 meters. A predetermined cutoff depth of 0.25 meters can be used in combination with the first depth distance to create a binary mask of the portion of the individual recording the video. The binary mask is created by leaving unchanged all pixel values registered by objects determined by the depth sensor as being between 0.75 and 1.00 meters from the camera, and setting to zero all pixel values registered by objects that are closer to the camera than 0.75 meters or farther away from the camera than 1.00 meter. The result is that only the image of the first individual remains; the performance of the first individual has been isolated from the background of the short-form video.

The flow 100 includes retrieving an image 130 that includes a representation of a second individual. In embodiments, the image can include multiple views of the second individual. The images can be captured from still photographs or videos. The flow 100 includes extracting information on the second individual 140 from the retrieved images. As stated above, AI algorithms can be used to separate an individual in the foreground of an image from the remainder of the image. In embodiments, the second individual can be extracted from the one or more images containing the second individual. The extracted images of the second individual can be used to generate a 3D model of the second individual's head, face, and in some implementations, upper body. In some embodiments, specific details of the second individual can be identified and used to enhance the performance of the second short-form video, which is detailed in later steps. Details such as gestures, articles of clothing, facial expressions, accessories, and background images can be identified and isolated for later use. AI and machine learning algorithms can be employed to locate minute changes in image frames of short-form videos of the second individual, group and categorize the changes, and record them for use in performances. The same detailed analysis can be used with the performance of the first individual. This allows attributes of the first individual's performance to be applied to the second individual's performance in the second short-form video.

The flow 100 includes replacing the performance of the first individual 150 in the short-form video with the second individual, wherein the replacing is accomplished by machine learning. In embodiments, the attributes of the first individual's 154 performance can be determined 152 and applied to the second individual 156. The first individual's attributes can include one or more gestures, articles of clothing, facial expressions, accessories, and the background of the first individual short-form video. Machine learning algorithms such as convolutional neural networks (CNNs) are used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate. CNN databases are reported to have a facial recognition rate of over 97% and they continue to improve.

In embodiments, replacing the first individual in the short-form video with the second individual is accomplished by generating neural network data models. The first neural network analyzes and learns to encode and decode the first individual's performance 154 in the short-form video. The second neural network analyzes and learns to encode and decode the second individual from a set of extracted images. Once both neural networks are built, the encoder for the second individual is combined with the decoder for the first individual. As each video frame is processed, the gestures, facial features, lighting, and movements of the first individual are decoded and encoded back into images using details from the second individual. In some embodiments, the resulting images are then analyzed using a generative adversarial network (GAN) which compares the “new” image to recorded images of the second individual. The GAN step will reject inaccurate images, which causes another round of decoding and encoding until a sufficiently accurate image of the second individual is obtained.

The flow 100 includes changing attributes of the second individual 160. In embodiments, the attributes of the second individual can include gestures, articles of clothing, facial expressions, accessories, background images, and products for sale. As mentioned above, images of a second individual can be retrieved from still photos and short-form videos and the details of the second individual can be extracted and used as input for a machine learning neural network. Facial recognition algorithms can be used to analyze elements of the images of the second individual and build a database of various characteristics. Additional elements can be added to the neural network database from multiple images of other individuals, broadening the range of changes that can be applied to a digital model of the second individual. For instance, an article of clothing such as a hat or scarf can be added to the image of the second individual and made to look as real as if the second individual had actually worn the item. In some embodiments, the attributes of the second individual can be changed to include interacting with and highlighting products for sale from a library of products that have been digitally recorded and mapped into the neural network database.

The flow 100 includes creating a second short-form video 170 combining the performance of the first individual with the images of the second individual. In embodiments, the performance of the first individual 120 is replaced by generating neural network data models. The first neural network analyzes and learns to encode and decode the first individual's performance 154 in the short-form video. The second neural network analyzes and learns to encode and decode the second individual from a set of extracted images. Once both neural networks are built, the encoder for the second individual is combined with the decoder for the first individual. As each frame is processed, the various attributes of the first individual, including gestures, facial features, lighting, and movements are decoded and encoded back into images using the neural network images from the second individual. In some embodiments, the resulting images are then analyzed using a generative adversarial network (GAN) which compares the “new” image to recorded images of the second individual. The GAN step will reject inaccurate images, which causes another round of decoding and encoding until a sufficiently accurate image of the second individual is obtained. The resulting second short-form video can be recorded and rendered 180 to viewers so that the actions, gestures, expressions, and appearance of the first individual appear to be performed by the second individual. In some embodiments, selected attributes of the second individual can be changed and included as part of the second short form video.

The flow 100 includes augmenting the second short-form video 190. In embodiments, after the second short-form video has been created and rendered, it can be used as part of a livestream event or replay. The augmenting of the second short-form video can be based on viewer interactions that occur during the livestream event. The augmenting can be accomplished dynamically through the use of an operator or AI generated responses to viewer comments or questions. In some embodiments, the viewer interactions can be obtained using polls, surveys, questions, answers, and so on. The responses to viewer comments can be based on products for sale which are highlighted during the livestream performance. In some embodiments, special offers or coupons can be included in the responses or during the highlighting of the products for sale. The augmenting can include shoutouts to viewers who make comments regarding products for sale, make a donation, purchase a subscription, etc.

The augmenting of the second short-form video 190 can include switching audio content in the second short-form video with additional audio that matches the voice of the second individual. In embodiments, the voice of a second individual can be recorded and used to create a neural network database that can be used to generate speech with the second individual's voice characteristics. In some embodiments, an imitation-based algorithm takes the spoken voice of the first individual as input to a voice conversion module. A neural network, such as a Generative Adversarial Network (GAN), can be used to record the style, intonation, and vocal qualities of both the first and second individuals, convert them into linguistic data, and use the characteristics of the second individual's voice to repeat the text of the first individual in a short-form video. For example, the first individual can speak the phrase, “My name is Joe.” The phrase can be recorded and analyzed. The text of the phrase can be processed along with the vocal characteristics of speed, inflection, emphasis, and so on. The text and vocal characteristics can then be replayed using the style, intonation, and vocal inflections of the second individual without changing the text, speed, or emphases of the first individual's statement. Thus, the same phrase, “My name is Joe” is heard in the voice of the second individual. The GAN processing can be used to incrementally improve the quality of the second individual's voice by comparing it to recordings of the second individual. As more data on the first individual and second individual's voices is collected, the ability to mimic the second individual's voice improves.

In some embodiments, the augmenting of the second short-form video 190 can include additional video performances of the first individual. In embodiments, the video and audio of the first individual can be replaced using the image and voice of the second individual in the manners described above. The result is that responses to viewer comments made during a livestream session can be generated and recorded in advance as part of a library of responses to frequently asked questions (FAQs). The responses can be added to the livestream event as needed based on the operator's response to viewer interactions. In some embodiments, the responses can be added by an AI system that analyzes the text of the viewer comments and selects an appropriate FAQ response.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

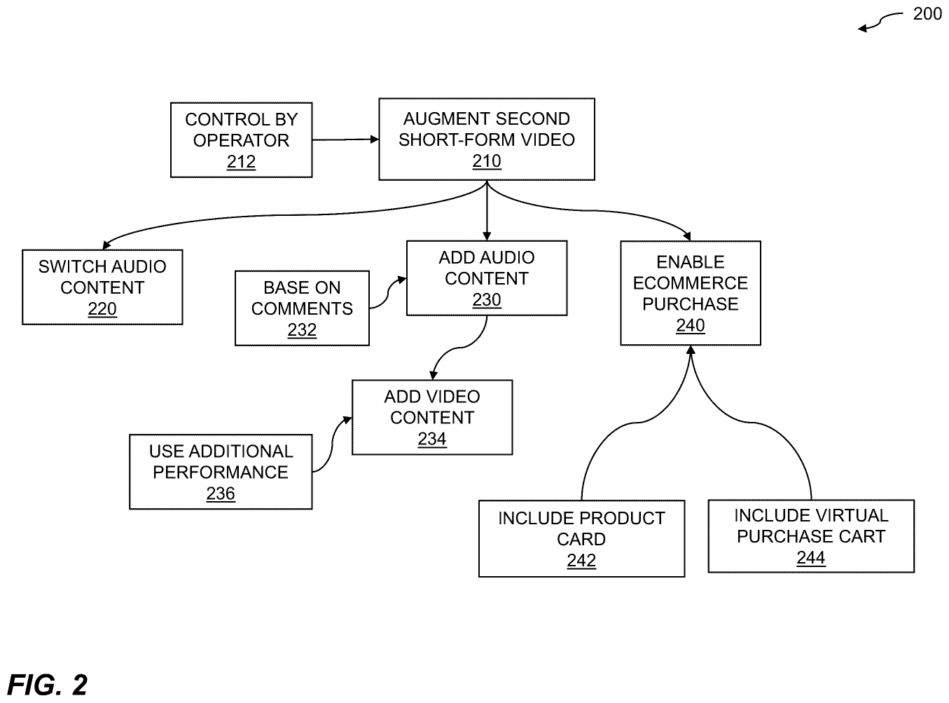

FIG. 2 is a flow diagram for augmenting a short-form video with an ecommerce purchase. A first short-form video that includes a performance by a first individual can be analyzed and used as the foundation of a second short-form video. The second short-form video replaces the performance of the first individual with a second individual. The image of the second individual can be recorded and used to generate a neural network database. The short-form video of the first individual can be used to generate another neural network database. The facial features, gestures, facial expressions, clothing, accessories, etc. of the first and second individuals can be used as part of the neural networks. The neural network of the second individual's image can be used to replace the image of the first individual in the first short-form video to create a second short-form video. The second short-form video portrays the same performance as the first short-form video using the face and features of the second individual. The second short-form video can be augmented to replace the voice of the first individual with the voice of the second individual, using similar neural network processes as used to replace the face of the first individual with the face of the second individual. Additional short-form videos of the first individual can be generated and processed in the same manner as the first short-form video so that the image and voice of the second individual are seen in the performance. The additional short-form videos can be used to create a library of responses to frequently asked questions (FAQs) that may arise as the second short-form video is viewed as part of a livestream event or replay. Products and services for sale can be a part of the library of responses. As products for sale are highlighted as part of a livestream event, ecommerce purchasing can be enabled. The ecommerce purchasing can include product cards and a virtual purchase cart.

The flow 200 includes augmenting a second short-form video 210. As described above and throughout, a first short-form video that includes a performance by a first individual can be analyzed and used as the foundation of a second short-form video. The second short-form video replaces the performance of the first individual with a second individual. The image of the second individual can be recorded and used to generate a neural network database. The short-form video of the first individual can be used to generate another neural network database. The facial features, gestures, facial expressions, clothing, accessories, etc. of the first and second individuals can be used as part of the neural networks. The neural network of the second individual's image can be used to replace the image of the first individual in the first short-form video to create a second short-form video. The second short-form video portrays the same performance as the first short-form video using the face and features of the second individual. Once the second short-form video has been generated and recorded, it can be augmented. In embodiments, the augmentation can include audio content, additional performances, responses to viewer interactions, and ecommerce purchase options as described below. The augmenting of the second short-form video 210 can be controlled by an operator 212. The second short-form video can be used as part of a livestream replay event. As the second short-form video is seen, viewers can join the livestream and interact using text windows, etc. The interactions can be based on comments 232 such as responses to polls and/or surveys posted during the event or questions and/or answers that are posted. As viewer comments are received, an operator 212 can respond to the comments, ask additional questions, display responses to polls, etc. The operator can also select responses from a library of frequently asked questions (FAQs) that can be generated in advance. The operator can be an artificial intelligence (AI) system or a human operator. In some embodiments, the AI operator can respond to text comments from viewers and select appropriate FAQ responses from a library of FAQ responses.

The flow 200 includes switching the audio content 220 of the second short-form video. In embodiments, the voice of a second individual can be recorded and used to create a neural network database that can be used to generate speech with the second individual's voice characteristics. In some embodiments, an imitation-based algorithm takes the spoken voice of the first individual as input to a voice conversion module. A neural network, such as a Generative Adversarial Network (GAN), can be used to record the style, intonation, and vocal qualities of both the first and second individuals, convert them into linguistic data, and use the characteristics of the second individual's voice to repeat the text of the first individual in a short-form video. Each sentence or phrase of a short-form video can be recorded and analyzed. The text of the phrase can be processed along with the vocal characteristics of speed, inflection, emphasis, and so on of the first individual. The text and vocal characteristics of the short-form video can then be replayed using the style, intonation, and vocal inflections of the second individual without changing the text, speed, or emphases of the first individual's statement. Thus, the same sentences and phrases made in the short-form video are heard in the voice of the second individual. The GAN processing can be used to incrementally improve the quality of the second individual's voice by comparing it to recordings of the second individual. As more data on the first individual and second individual's voices is collected, the ability to mimic the second individual's voice improves.

The flow 200 includes augmenting the second short-form video 210 with added audio content 230. In embodiments, audio content can be generated by a first individual and used to create audio content in the voice of a second individual. The audio comments can be added to the second short-form video and recorded in order to augment the content of the video. In some embodiments, an operator 212 can access a library of audio comments created in advance and play them as part of a livestream event. In some embodiments, a first individual can participate in a livestream event based on the second short-form video. As the second short-form video is viewed, comments from viewers can be made. The first individual can respond to the viewer comments. An operator 212 can capture the responses made by the first individual and use a neural network to substitute the voice of a second individual, so that the vocal responses to the viewer comments heard as part of the livestream event are in the voice of the second individual.

The flow 200 includes augmenting the second short-form video 210 with additional video content 234. As with the added audio content 230 described above and throughout, video content can be generated by a first individual and used to create video content with the face and features of a second individual. The video content can be added to the second short-form video and recorded in order to augment the content of the video. In some embodiments, an operator 212 can access a library of short-form videos created in advance and play them as part of a livestream event. In some embodiments, a first individual can participate in a livestream event based on the second short-form video. As the second short-form video is viewed, comments from viewers can be made. The first individual can respond to the viewer comments. An operator 212 can capture the responses made by the first individual and use a neural network to substitute the face and features of a second individual, so that the responses to the viewer comments viewed as part of the livestream event are seen as the second individual. In some embodiments, the audio content of the first individual can be switched along with the face and features of the first individual, so that the responses to viewer comments made during the livestream event are made with the face, features, and voice of the second individual. The responses to viewers can include comments on live polls or surveys; responses to questions and answers made during a livestream event; shoutouts to viewers in response to donations, purchases, or subscriptions being made; etc. In some embodiments, the responses can be made in real time or can be selected from a FAQ library created in advance. The FAQ responses can be additional short-form videos 234 or audio responses 230. The additional short-form video or audio responses can be generated in the same manner that the second short-form video was created. Additional first individual performance 236 short-form videos can be created and used as input to generate additional second short-form videos using the face and features of the second individual. The voice of the second individual can be substituted for the voice of the first individual in the same manner that the face and features were substituted.

The flow 200 includes augmenting a second short-form video 210 by enabling ecommerce purchases 240. In embodiments, an individual in the second short-form video can perform as the host of a livestream event. Added audio content 230 and video content 234 can include highlighting products and services for sale during the livestream event. The host can demonstrate, endorse, recommend, and otherwise interact with one or more products for sale. An ecommerce purchase of at least one product for sale can be enabled to the viewer, wherein the ecommerce purchase is accomplished within the livestream window. As the host interacts with and presents the products for sale, a product card 242 can be included within a livestream shopping window. An ecommerce environment associated with the livestream event can be generated on the viewer's mobile device or other connected video device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer. The viewer can purchase the product through the ecommerce environment, which includes a virtual purchase cart 244. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In embodiments, the second short-form video that was rendered displays the virtual purchase cart while the second short-form video plays.

The flow 200 includes a product card 242 that represents one or more products for sale during a livestream event. In embodiments, the inclusion of a product card 242 can be accomplished, using one or more processors, by the livestream host within an ecommerce purchase window on the viewer's device. The including of the product card 242 can include inserting a representation of a product or service for sale into the on-screen product card. A product card is a graphical element such as an icon, thumbnail picture, thumbnail video, symbol, or other suitable element that is displayed in front of the video. When the product card is invoked, an additional on-screen shopping window is rendered over a portion of the livestream video while the video continues to play. This rendering enables a viewer to view purchase information about a product/service while preserving a continuous video playback session.

The flow 200 includes a virtual purchase cart 244 rendered to the viewer during a livestream event. The virtual purchase cart can appear as an icon, a pictogram, a representation of a purchase cart, and so on. The virtual purchase cart can appear as a cart, a basket, a bag, a tote, a sack, and the like. Using a mobile or other connected television (CTV) device, such as a smart TV; a television connected to the Internet via a cable box, TV stick, or game console; pad; tablet; laptop; or desktop computer; etc., the viewer can click on the product or on the virtual purchase cart to add the product to the purchase cart. The viewer can click again on the virtual purchase cart to open the cart to display the cart contents. The viewer can save the cart, edit the contents of the cart, delete items in the cart, etc. In some embodiments, the virtual purchase cart rendered to the viewer can cover a portion of the livestream window. The portion of the livestream window can range from a small portion to substantially all of the livestream window. However much of the livestream window is covered by the virtual purchase cart, the livestream event continues to play while the viewer is interacting with the virtual purchase cart.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

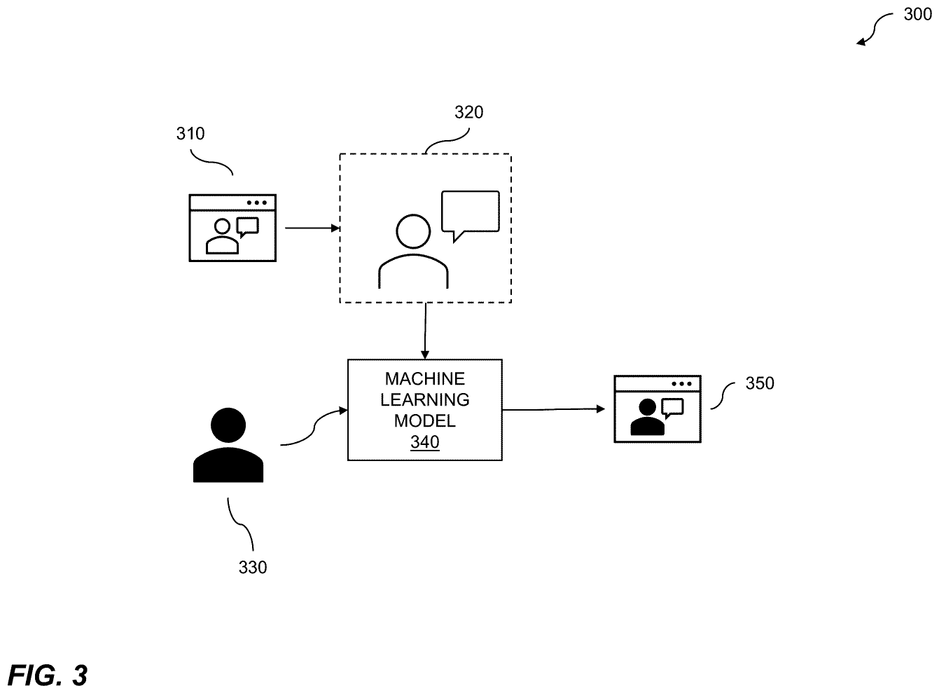

FIG. 3 is an infographic for augmented performance replacement in a short-form video. As described above and throughout, a first short-form video that includes a performance by a first individual can be accessed. The first individual can be a human or a computer-generated performer. The performance of the first individual in the first short-form video can be isolated using one or more processors. The isolated performance of the first individual in the short-form video can be used to generate a neural network database. The facial features, gestures, facial expressions, clothing, accessories, etc. of the first individual can be used as part of the neural network. The neural network can be used with an autoencoder that encodes and compresses the video data from the first short-form video. The encoding and compression process reduces the isolated first individual video data to its most basic features. The encoded data can then be used to create a more versatile model that can accept input data from a second neural network. The data from the second neural network can be used to create a new image combining elements from the first neural network and the second neural network.

The second neural network analyzes and learns to encode and compress image data from a second individual obtained from a set of extracted images. The extracted images can be obtained from still photographs or videos. Once both neural networks are built, the data from the second individual is used as input for the autoencoder from the first individual. As each frame of the first short-form video is processed, the gestures, facial features, lighting, and movements of the first individual are encoded and compressed. Using data from the second individual's neural network, the autoencoder of the first individual can be used to generate images using details from the second individual. The result is a second short-form video in which the second individual replaces the isolated performance of the first individual. In some embodiments, the resulting images are then analyzed using a generative adversarial network (GAN) which compares the “new” images to recorded images of the second individual. The GAN step will reject inaccurate images, which causes another round of autoencoding until a sufficiently accurate image of the second individual is obtained.

The infographic 300 includes a first short-form video 310 that includes a performance by a first individual. In embodiments, the first individual performance can be delivered by a human or a computer-generated AI model. The first individual performance can be isolated 320 within the first short-form video using one or more processors. In some embodiments, artificial intelligence (AI) algorithms are used to detect the subject in the foreground of the video, mask the foreground image, and remove the background elements. In some embodiments, video data from the short-form video can be synchronized with depth data captured by a depth sensor camera used along with the short-form video camera. A depth sensor camera, also known as a Time of Flight or ToF camera, uses pulses of laser light to create a three-dimensional map of an image, such as an individual recording a video of him- or herself. The map can be generated in real time and used to apply various effects to images and videos. The rate at which the depth sensor camera produces the three-dimensional map must be synchronized to the frame rate used by the first video camera. The video content can be used to detect the presence of an individual (or a portion thereof), or the face of an individual in the video. Face detection can be done using artificial-intelligence-based technology to locate human faces in digital images. Once AI algorithms detect a face in a digital image, additional datasets can be used to compare facial features in order to match a face located in video image with a previously stored faceprint and complete the recognition of a particular individual. Data from a depth sensor camera can be used to determine the distance between the short-form video camera and the face of the first individual. The first depth can be combined with a predetermined cutoff depth, for example 0.25 meters, to set the maximum distance from the first camera in order to generate a binary mask. A binary mask is a digital image consisting of zero and non-zero values. In some embodiments, a binary mask can be used to filter out all digital pixel data that is determined to come from objects that are either closer or farther away from the camera than the first depth or cutoff depth. For example, a first individual with a camera facing toward the individual records a short-form video. A depth sensor camera determines the distance from the camera to the individual's face as 0.75 meters. A predetermined cutoff depth of 0.25 meters can be used in combination with the first depth distance to create a binary mask of the portion of the individual recording the video. The binary mask is created by leaving unchanged all pixel values registered by objects determined by the depth sensor as being between 0.75 and 1.00 meters from the camera and setting to zero all pixel values registered by objects that are closer to the camera than 0.75 meters or farther away from the camera than 1.00 meter. The result is that only the image of the first individual remains; the performance of the first individual has been isolated from the background of the short-form video.

The infographic 300 includes an image of a second individual 330. In embodiments, the image can include multiple views of the second individual. The images can be captured from still photographs or videos. As with the first individual, information on the second individual 330 can be extracted from the retrieved images. As stated above, AI algorithms can be used to separate an individual within an image from the remainder of the image. The extracted images of the second individual can be used to generate a 3D model of the second individual's head, face, and in some embodiments, upper body. In some embodiments, specific details of the second individual can be identified and used to enhance the performance of the second short-form video detailed in later steps. Details such as gestures, articles of clothing, facial expressions, accessories, and background images can be identified and isolated for later use. AI and machine learning algorithms can be employed to locate small changes in image frames of short-form videos of the second individual, group and categorize the changes, and record them for use in performances. The same detailed analysis can be used with the performance of the first individual. This allows attributes of the first individual's performance to be applied to the second individual's performance in a second short-form video.

The infographic 300 includes a machine learning model 340. In embodiments, the attributes of the first individual's isolated performance 320 can be determined and applied to the second individual 330. The first individual's attributes can include one or more gestures, articles of clothing, facial expressions, accessories, and the background of the first individual short-form video. In some embodiments, machine learning algorithms such as convolutional neural networks (CNNs) can be used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate.

In some embodiments, replacing the first individual in the short-form video with the second individual is accomplished by generating neural network data models. The first neural network analyzes and learns to encode and decode the first individual's performance 320 in the short-form video 310. A second neural network analyzes and learns to encode and decode the second individual 330 from a set of extracted images. Once both neural networks are built, the encoder for the second individual is combined with the decoder for the first individual. As each frame is processed, the gestures, facial features, lighting, and movements of the first individual are decoded and encoded back into images using details from the second individual. In some embodiments, the resulting images are then analyzed using a generative adversarial network (GAN) which compares the “new” image to recorded images of the second individual. The GAN step will reject inaccurate images, which causes another round of decoding and encoding until a sufficiently accurate image of the second individual is obtained. The infographic 300 includes a second short-form video created by the machine learning model 340. In embodiments, as the machine learning model 340 combines the image data of the second individual 330 with the isolated performance of the first individual 320, a second short-form video is generated 350. The second short-form video shows the entire performance of the first individual being accomplished by the second individual. The second short-form video can be recorded and augmented with additional audio and video elements in later steps.

In some embodiments, the machine learning model can be used to change attributes of the second individual in the second short-form video. The attributes of the second individual can include gestures, articles of clothing, facial expressions, accessories, background images, and products for sale. As mentioned above and throughout, images of a second individual can be retrieved from still photos and short-form videos, and the details of the second individual can be extracted and used as input for a machine learning neural network 340. Facial recognition algorithms can be used to analyze elements of the images of the second individual and build a database of various characteristics. Additional elements can be added to the neural network database from multiple images of other individuals, broadening the range of changes that can be applied to a digital model of the second individual. For instance, an article of clothing such as a hat or scarf can be added to the image of the second individual and made to look as real as if the second individual had actually worn the item. In some embodiments, the attributes of the second individual can be changed to include interacting with and highlighting products for sale from a library of products that have been digitally recorded and mapped into the neural network database.

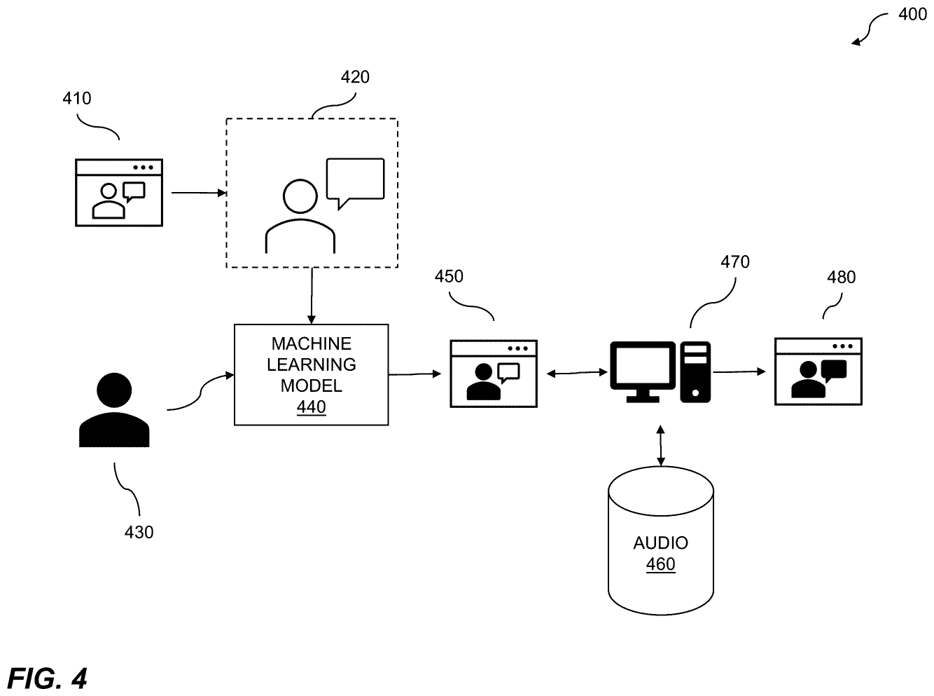

FIG. 4 is an infographic for switching audio content by an operator. As described above and throughout, a first short-form video that includes a performance by a first individual can be accessed. The first individual can be a human or a computer-generated performer. The performance of the first individual in the first short-form video can be isolated using one or more processors. The isolated performance of the first individual in the short-form video can be used to generate a neural network database to be used in a machine learning model. The facial features, gestures, facial expressions, clothing, accessories, etc. of the first individual can be used as input data to the neural network. The neural network can be used with an autoencoder that encodes and compresses the video data from the first short-form video. The encoding and compression process reduces the isolated first individual video data to its most basic features. The encoded data can then be used to create a more versatile model that can accept input data from a second neural network. The data from the second neural network can be used to create a new image combining elements from the first neural network and the second neural network.

The second neural network analyzes and learns to encode and compress image data from a second individual obtained from a set of extracted images. The extracted images can be obtained from still photographs or videos. Once both neural networks are built, the data from the second individual is used as input for the autoencoder from the first individual. As each frame of the first short-form video is processed, the gestures, facial features, lighting, and movements of the first individual are encoded and compressed. Using data from the second individual's neural network, the autoencoder of the first individual can be used to generate images using details from the second individual. The result is a second short-form video in which the second individual replaces the isolated performance of the first individual. In some embodiments, the resulting images are then analyzed using a generative adversarial network (GAN) which compares the “new” images to recorded images of the second individual. The GAN step will reject inaccurate images, which causes another round of autoencoding until a sufficiently accurate image of the second individual is obtained.

After the second short-form video is generated by the machine learning model, the video can be augmented by switching the first individual audio content with additional audio content that matches the voice of the second individual. Additional performances from the first individual can be added to the second short-form video, after switching in the voice of the second individual. A library of audio comments and responses can be generated and stored for use during a livestream event. An operator can access the audio library to perform the audio content switching. The operator can be a human or an AI operator. The result is an augmented second short-form video that shows the performance of the first individual executed by a second individual, including the face and voice of the second individual.

The infographic 400 includes a first short-form video 410 that includes a performance by a first individual. In embodiments, the first individual performance can be delivered by a human or a computer-generated AI model. The first individual performance can be isolated 420 within the first short-form video using one or more processors. In some embodiments, artificial intelligence (AI) algorithms are used to detect the subject in the foreground of the video, mask the foreground image, and remove the background elements. In some embodiments, video data from the short-form video can be synchronized with depth data captured by a depth sensor camera used along with the short-form video camera. A depth sensor camera, also known as a Time of Flight or ToF camera, uses pulses of laser light to create a three-dimensional map of an image, such as an individual recording a video of him- or herself. The map can be generated in real time and can be used to apply various effects to images and videos. The rate at which the depth sensor camera produces the three-dimensional map must be synchronized to the frame rate used by the first video camera. The video content can be used to detect the presence of an individual (or a portion thereof), or the face of an individual in the video. Face detection can be done using artificial-intelligence-based technology to locate human faces in digital images.

Once AI algorithms detect a face in a digital image, additional datasets can be used to compare facial features in order to match a face located in video image with a previously stored faceprint and complete the recognition of a particular individual. Data from a depth sensor camera can be used to determine the distance between the short-form video camera and the face of the first individual. The first depth can be combined with a predetermined cutoff depth, for example 0.25 meters, to set the maximum distance from the first camera in order to generate a binary mask. A binary mask is a digital image consisting of zero and non-zero values. In some embodiments, a binary mask can be used to filter out all digital pixel data that is determined to come from objects that are either closer or farther away from the camera than the first depth or cutoff depth. For example, a first individual with a camera facing toward the individual records a short-form video. A depth sensor camera determines that the distance from the camera to the individual's face is 0.75 meters. A predetermined cutoff depth of 0.25 meters can be used in combination with the first depth distance to create a binary mask of the portion of the individual recording the video. The binary mask is created by leaving unchanged all pixel values registered by objects determined by the depth sensor as being between 0.75 and 1.00 meters from the camera and setting to zero all pixel values registered by objects that are closer to the camera than 0.75 meters or farther away from the camera than 1.00 meter. The result is that only the image of the first individual remains; the performance of the first individual has been isolated from the background of the short-form video.

The infographic 400 includes an image of a second individual 430. In embodiments, the image can include multiple views of the second individual. The images can be captured from still photographs or videos. As with the first individual, information on the second individual 430 can be extracted from the retrieved images. As stated above, AI algorithms can be used to separate an individual within an image from the remainder of the image. The extracted images of the second individual can be used to generate a 3D model of the second individual's head, face, and in some embodiments, upper body. In some embodiments, specific details of the second individual can be identified and used to enhance the performance of the second short-form video detailed in later steps. Details such as gestures, articles of clothing, facial expressions, accessories, and background images can be identified and isolated for later use. AI and machine learning algorithms can be employed to locate small changes in image frames of short-form videos of the second individual, group and categorize the changes, and record them for use in performances. The same detailed analysis can be used with the performance of the first individual. This allows attributes of the first individual's performance to be applied to the second individual's performance in a second short-form video.

The infographic 400 includes a machine learning model 440. In embodiments, the attributes of the first individual's isolated performance 420 can be determined and applied to the second individual 430. The first individual's attributes can include one or more gestures, articles of clothing, facial expressions, accessories, and the background of the first individual short-form video. In some embodiments, machine learning algorithms 440, such as convolutional neural networks (CNNs), can be used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate.

In some embodiments, replacing the first individual in the short-form video with the second individual is accomplished by generating neural network data models. The first neural network analyzes and learns to encode and decode the first individual's performance in the short-form video. A second neural network analyzes and learns to encode and decode the second individual 430 from a set of extracted images. Once both neural networks are built, the encoder for the second individual is combined with the decoder for the first individual. As each frame is processed, the gestures, facial features, lighting, and movements of the first individual are decoded and encoded back into images using details from the second individual. In some embodiments, the resulting images are then analyzed using a generative adversarial network (GAN) which compares the “new” image to recorded images of the second individual. The GAN step will reject inaccurate images, which causes another round of decoding and encoding until a sufficiently accurate image of the second individual is obtained. The infographic 400 includes a second short-form video 450 created by the machine learning model 440. In embodiments, as the machine learning model combines the image data of the second individual with the isolated performance of the first individual, a second short-form video is generated. The second short-form video shows the entire performance of the first individual being accomplished by the second individual. The second short-form video 450 can be recorded and augmented with additional audio and video elements in later steps.

The infographic 400 includes a database of audio content 460 that matches the voice of the second individual included in the second short-form video. In embodiments, the voice of a second individual can be recorded and used to create a neural network database that can be used to generate speech with the second individual's voice characteristics. In some embodiments, an imitation-based algorithm takes the spoken voice of the first individual as input to a voice conversion module. A neural network, such as a Generative Adversarial Network (GAN), can be used to record the style, intonation, and vocal qualities of both the first and second individuals, convert them into linguistic data, and use the characteristics of the second individual's voice to repeat the text of the first individual in a short-form video. For example, the first individual can speak the phrase, “This vacation offer is wonderful!” The phrase can be recorded and analyzed. The text of the phrase can be processed along with the vocal characteristics of speed, inflection, emphasis, and so on. The text and vocal characteristics can then be replayed using the style, intonation, and vocal inflections of the second individual without changing the text, speed, or emphases of the first individual's statement. Thus, the same phrase, “This vacation offer is wonderful!” is heard in the voice of the second individual. The GAN processing can be used to incrementally improve the quality of the second individual's voice by comparing it to recordings of the second individual. As more data on the first individual and second individual's voices is collected, the ability to mimic the second individual's voice improves.

The infographic 400 includes an operator 470. In embodiments, the operator can be a human or an AI computer system. The operator can augment the second short-form video 450 with audio from an audio library 460. The second short-form video can be used as part of a livestream replay event. As the second short-form video is seen, viewers can join the livestream and interact using text windows, etc. The interactions can include comments such as responses to polls or surveys posted during the event or questions and answers that are posted. As viewer comments are received, an operator 470 can respond to the comments, ask additional questions, display responses to polls, etc. The operator can also select audio responses that can be generated in advance and stored in the audio library 460 in response to frequently asked questions (FAQs). In some embodiments, the AI operator can respond to text comments from viewers and select appropriate FAQ responses from the audio library 460. The result is a livestream event 480 created from a second short-form video 450 combining a first individual performance with the face and voice of a second individual 430. An operator can dynamically respond to viewer comments and questions by selecting audio from an audio library 460 in real time. The audio library responses can match the voice of the second individual that appears in the livestream short-form video.

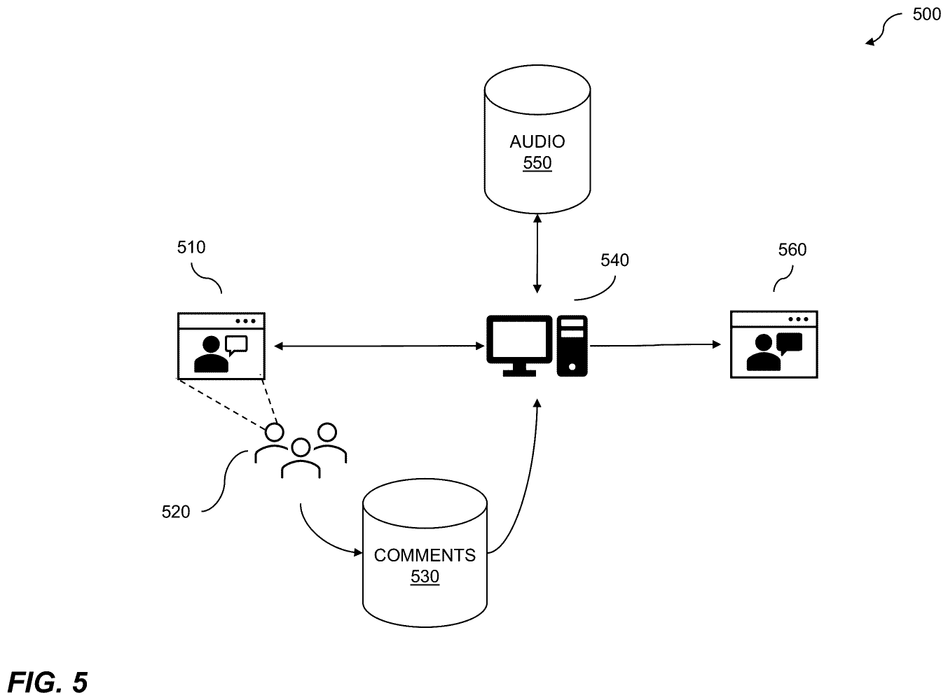

FIG. 5 is an infographic for adding audio content based on viewer comments. As described above and throughout, a machine learning model can be used to combine an isolated performance of a first individual with extracted image data of a second individual to create a second short-form video. The second short-form video shows the entire performance of the first individual being accomplished by the second individual. The second short-form video can be recorded and augmented with additional audio elements. Additional short-form video or audio recordings can be produced using the first individual. The additional short-form videos or audio recordings can be processed in the same manner as the first short-form video using the same machine learning models to generate a library of audio recordings using the voice of the second individual. The library of audio recordings can be accessed by an operator and used to respond to viewer comments during a livestream event or replay. Additional audio comments can be added to the second short-form video to augment the video and can be saved for future use.

The infographic 500 includes a second short-form video 510. In embodiments, the short-form video can be created from a short-form video that includes a performance by a first individual. The first individual can be a human performer or in some embodiments, the first individual can be an AI computer-generated model. One or more images that include a representation of a second individual can be retrieved, and detailed information on the second individual can be obtained from the images. The retrieved images can be in the forms of still photographs or videos. A machine learning model can be used to create a second short-form video 510 that replaces the performance of the first individual with the second individual. The result is to render a second short-form video that shows the entire performance of the first individual being accomplished by the second individual.

The infographic 500 includes viewers 520 watching the second short-form video 510 as a livestream event or replay. In embodiments, the second short-form video can be played for viewers as a livestream event. A livestream event is an interactive audio-visual session that can be initiated by using a video source and an audio source that are accessible to a computing device. In embodiments, the performance of the second individual in the second short-form video 510 can be viewed as the host of the livestream event. Viewers 520 can watch the livestream event using a connected television (CTV). A connected television (CTV) is any television set connected to the Internet. They are most commonly used to stream videos. As well as smart TVs with built-in internet connectivity, CTVs can include televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box. For example, watching a movie or television episode using a laptop or mobile phone browser is considered OTT. Any of these devices or services can be used to access livestream events as they occur or as they are replayed by a host system at a later time. In embodiments, viewers 520 can participate in the livestream event by accessing a website made available by the livestream host using an OTT such as a mobile phone, tablet, pad, laptop computer, or desktop computer. Participants in a livestream event can take part in chats, respond to polls, ask questions, make comments, and purchase products for sale that are highlighted during the livestream event. In some embodiments, the interactions between viewers and the livestream host can be accomplished by an operator 540 dynamically selecting audio responses 550 to viewer comments 530 as the livestream event occurs.

The infographic 500 includes comments 530 made by viewers as the livestream event occurs. In embodiments, participants in a livestream event can take part in chats, respond to polls, ask questions, make comments, and purchase products for sale that are highlighted during the livestream event. Comments 530 made by participants can be captured as text and seen by viewers and other participants in the livestream using CTV devices or interactive OTT devices.

The infographic 500 includes an operator 540. In embodiments, the operator 540 of the livestream event 510 can be a human or an AI computer-generated model. The comments 530 made by participants, or viewers, 520 in the livestream event 510, including responses to polls, surveys, questions, etc., can be seen by the livestream operator 540. As the comments are seen by the livestream operator 540, the operator can select audio 550 responses and comments that have been recorded in advance and stored in a library. In embodiments, the audio responses can be generated and recorded by the first individual that performed in the first short-form video. The audio responses can be processed using a machine learning model to switch the voice of the first individual with the voice of the second individual used in the second short-form video. The voice of a second individual can be recorded and used to create a neural network database that can be used to generate speech with the second individual's voice characteristics. In some embodiments, an imitation-based algorithm takes the spoken voice of the first individual as input to a voice conversion module. A neural network, such as a Generative Adversarial Network (GAN) can be used to record the style, intonation, and vocal qualities of both the first and second individuals, convert them into linguistic data, and use the characteristics of the second individual's voice to repeat the text of the first individual in a short-form video. For example, the first individual can speak the phrase, “My name is Joe.” The phrase can be recorded and analyzed. The text of the phrase can be processed along with the vocal characteristics of speed, inflection, emphasis, and so on. The text and vocal characteristics can then be replayed using the style, intonation, and vocal inflections of the second individual without changing the text, speed, or emphases of the first individual's statement. Thus, the same phrase, “My name is Joe” is heard in the voice of the second individual. The GAN processing can be used to incrementally improve the quality of the second individual's voice by comparing it to recordings of the second individual. As more data on the first individual and second individual's voices are collected, the ability to mimic the second individual's voice improves.

In some embodiments, the first individual can participate in the livestream event as it occurs. The operator 540 can use a machine learning model to record the voice of the first individual as the first individual responds to comments 530 made by viewer participants 520 of the livestream event 510. The machine learning model can be used to dynamically switch the voice of the first individual with the voice of the second individual seen in the short-form video. Thus, the livestream event 510 can be augmented 560 by audio content 550 dynamically added to the livestream event by an operator 540. In some embodiments, the audio content 550 can be recorded and stored in a library in advance or generated in real time during the livestream event by the first individual. In some embodiments, an AI computer-generated operator can analyze text comments 530 made by participants 520 as they occur during the livestream event 510 and select the best response available from the audio library 550. The audio responses can include highlighting products for sale during the livestream event, special offers or coupons related to the products for sale, and shoutouts to livestream participants in response to a donation, purchase, or subscription.

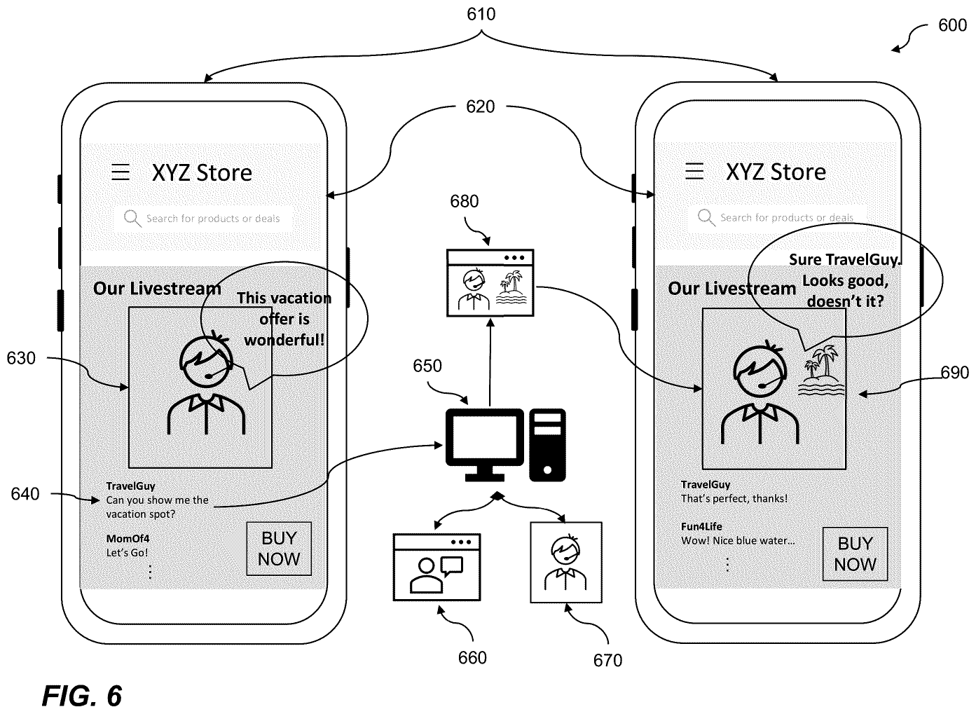

FIG. 6 is an infographic for augmenting content in a livestream. As described above and throughout, a machine learning model can be used to combine an isolated performance of a first individual with extracted image data of a second individual to create a second short-form video is generated. The second short-form video shows the entire performance of the first individual being accomplished by the second individual. The second short-form video can be recorded and augmented with additional audio elements. Additional short-form video or audio recordings can be produced using the first individual. The additional short-form videos or audio recordings can be processed in the same manner as the first short-form video using the same machine learning models to generate libraries of video and audio recordings using the face, features, and voice of the second individual. The libraries of video and audio recordings can be accessed by an operator and used to respond to viewer comments during a livestream event or replay. Additional comments can be added to the second short-form video to augment the video, and can be saved for future use. The additional comments can include highlighting products for sale during a livestream event based on the second short-form video.

The infographic 600 includes a CTV device 610 that can be used to participate in a livestream event. A connected television (CTV) is any television set connected to the Internet, including smart TVs with built-in internet connectivity, televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box. In embodiments, viewers can participate in the livestream event by accessing a website made available by the livestream host using a CTV device such as a mobile phone, tablet, pad, laptop computer, or desktop computer. Participants in a livestream event can take part in chats, respond to polls, ask questions, make comments, and purchase products for sale that are highlighted during the livestream event.

The infographic 600 includes a livestream event 620 based on a replay of a short-form video 660 made by a first individual. The first individual performance in the short-form video 660 can be delivered by a human or generated by artificial intelligence. The infographic 600 includes isolating the performance of the first individual in the short-form video 660. In embodiments, artificial intelligence (AI) algorithms are used to detect the subject in the foreground of the video, mask the foreground image, and remove the background elements. In some embodiments, video data from the short-form video is synchronized with depth data captured by a depth sensor camera used along with the short-form video camera. A depth sensor camera, also known as a Time of Flight or ToF camera, uses pulses of laser light to create a three-dimensional map of an image, such as an individual recording a video of him- or herself. The map can be generated in real time and used to apply various effects to images and videos. The rate at which the depth sensor camera produces the three-dimensional map must be synchronized to the frame rate used by the first video camera. The video content can be used to detect the presence of an individual (or a portion thereof), or the face of an individual in the video 660. Face detection can be done using artificial-intelligence-based technology to locate human faces in digital images. Once AI algorithms detect a face in a digital image, additional datasets can be used to compare facial features in order to match a face located in a video image with a previously stored faceprint and to accomplish the recognition of a particular individual. Data from a depth sensor camera can be used to determine the distance between the short-form video camera and the face of the first individual. The first depth can be combined with a predetermined cutoff depth, for example 0.25 meters, to set the maximum distance from the first camera in order to generate a binary mask. A binary mask is a digital image consisting of zero and non-zero values. In some embodiments, a binary mask can be used to filter out all digital pixel data that is determined to come from objects that are either closer or farther away from the camera than the first depth or cutoff depth. For example, a first individual with a camera facing toward the individual records a short-form video. A depth sensor camera determines that the distance from the camera to the individual's face is 0.75 meters. A predetermined cutoff depth of 0.25 meters can be used in combination with the first depth distance to create a binary mask of the portion of the individual recording the video. The binary mask is created by leaving unchanged all pixel values registered by objects determined by the depth sensor as being between 0.75 and 1.00 meters from the camera, and setting to zero all pixel values registered by objects that are closer to the camera than 0.75 meters or farther away from the camera than 1.00 meter. The result is that only the image of the first individual remains; the performance of the first individual has been isolated from the background of the short-form video.

The infographic 600 includes retrieving an image 670 that includes a representation of a second individual. In embodiments, the image can include multiple views of the second individual. The images can be captured from still photographs or videos. The infographic 600 includes extracting information on the second individual from the retrieved images 670. As stated above and throughout, AI algorithms can be used to separate an individual in the foreground of an image from the remainder of the image. In embodiments, the second individual can be extracted from the one or more images containing the second individual. The extracted images of the second individual can be used to generate a 3D model of the second individual's head, face, and in some implementations, upper body. In some embodiments, specific details of the second individual can be identified and used to enhance the performance of the second short-form video, which is detailed in later steps. Details such as gestures, articles of clothing, facial expressions, accessories, and background images can be identified and isolated for later use. AI and machine learning algorithms are employed to locate minute changes in image frames of short-form videos of the second individual, to group and categorize the changes, and to record them for use in performances. The same detailed analysis can be used with the performance of the first individual. This allows attributes of the first individual's performance to be applied to the second individual's performance in the second short-form video.

The infographic 600 includes replacing the performance of the first individual in the short-form video with the second individual, wherein the replacing is accomplished by machine learning. In embodiments, the attributes of the first individual's performance can be determined and applied to the second individual. The first individual's attributes can include one or more gestures, articles of clothing, facial expressions, accessories, and the background of the first individual short-form video. Machine learning algorithms such as convolutional neural networks (CNNs) are used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate. CNN databases are reported to have a facial recognition rate of over 97% and they continue to improve.

The infographic 600 includes augmenting the second short-form video 630. In embodiments, after the second short-form video has been rendered, it can be used as part of a livestream event or replay. The augmenting of the second short-form video can be based on viewer interactions 640 that occur during the livestream event. The augmenting can be done dynamically through the use of an operator 650 to viewer comments 640 or questions. In some embodiments, the viewer interactions can be accomplished using polls, surveys, questions and answers, and so on. The responses to viewer comments can be based on products for sale which are highlighted during the livestream performance. For example, in the FIG. 6 infographic, the second individual host says, “This vacation offer is wonderful!” A participant in the livestream responds by asking, “Can you show me the vacation spot?” The operator 650 can dynamically respond to the participant's question by obtaining an image or short-form video of the product for sale, in this case, the vacation spot, and adding it into the livestream feed 680. The operator 650 can further respond 690 to the participant's reply, “That's perfect, thanks!” with the comment, “Sure TravelGuy. Looks good, doesn't it?” In some embodiments, the phrase “Sure . . . Looks good, doesn't it?” can be a pre-recorded video comment so that the username “TravelGuy” is the only portion of the response that is added dynamically during the livestream event by the operator. In some embodiments, an AI operator can analyze the text of the comments made by participants and select the appropriate audio or video responses from libraries of responses made in advance. The result is a livestream event 620 that can include dynamic interactions between viewers 640 and the livestream host based on operator 650 responses to viewer comments made during the livestream event. The foundation of the livestream event 620 can be a short-form video rendered from a machine learning model using images of a second individual to replace the performance of a first individual. The resulting second short-form video can be augmented by swapping the voice of the first individual with the voice of the second individual using a similar machine learning model technique to the process used to accomplish the image swapping. In embodiments, the augmenting is used to train the machine learning model.

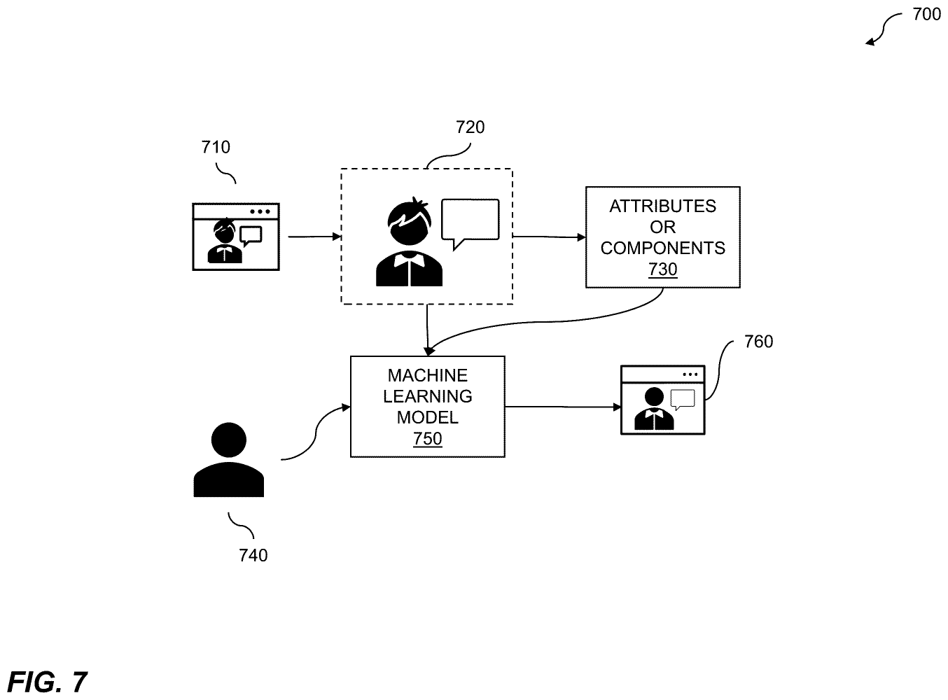

FIG. 7 is an infographic for applying attributes of the first individual. During the analysis of a first short-form video, attributes of the first individual's performance can be determined and applied to the second individual. The first individual's attributes can include one or more gestures, articles of clothing, facial expressions, accessories, and the background of the first individual short-form video.

The infographic 700 includes a short-form video 710 that includes a performance by a first individual. In embodiments, the first individual performance can be delivered by a human or generated by artificial intelligence. The infographic 700 includes isolating the performance of the first individual 720 in the short-form video. In embodiments, artificial intelligence (AI) algorithms are used to detect the subject in the foreground of the video, mask the foreground image, and remove the background elements. The result is that only the image of the first individual remains; the performance of the first individual has been isolated from the background of the short-form video.

The infographic 700 includes determining the attributes and/or components 730 of the first individual's performance. In embodiments, the first individual's attributes can include one or more gestures, articles of clothing, facial expressions, accessories, and the background of the first individual short-form video. Machine learning models 750, such as convolutional neural networks (CNNs), can be used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate. CNN databases are reported to have a facial recognition rate of over 97% and they continue to improve.

The infographic 700 includes retrieving an image 740 that includes a representation of a second individual. In embodiments, the image can include multiple views of the second individual. The images can be captured from still photographs or videos. The infographic 700 includes extracting information on the second individual from the retrieved images. As stated above and throughout, AI algorithms can be used to separate an individual in the foreground of an image from the remainder of the image. In embodiments, the second individual can be extracted from the one or more images containing the second individual. The extracted images of the second individual can be used by a machine learning model 750 to generate a 3D model of the second individual's head, face, and in some implementations, upper body. The same detailed analysis can be used with the performance of the first individual 720. This allows attributes or components 730 of the first individual's performance to be applied to the second individual's performance in the second short-form video 760.

The infographic 700 includes creating a second short-form video 760 combining the isolated performance of the first individual with the images of the second individual 740. In embodiments, the performance of the first individual is replaced by generating neural network data replicas within a machine learning model 750. The first neural network analyzes and learns to encode and decode the first individual's performance in the short-form video. The second neural network analyzes and learns to encode and decode the second individual from a set of extracted images 740. Once both neural networks are built, the encoder for the second individual is combined with the decoder for the first individual. As each frame is processed, the various attributes of the first individual, including gestures, facial features, lighting, and movements, are decoded and then encoded back into images using the neural network images from the second individual. The resulting second short-form video 760 can be generated by the machine learning model 750 and recorded so that the attributes of the first individual, including actions, gestures, expressions, clothing, and accessories, all appear to be performed or worn by the second individual.

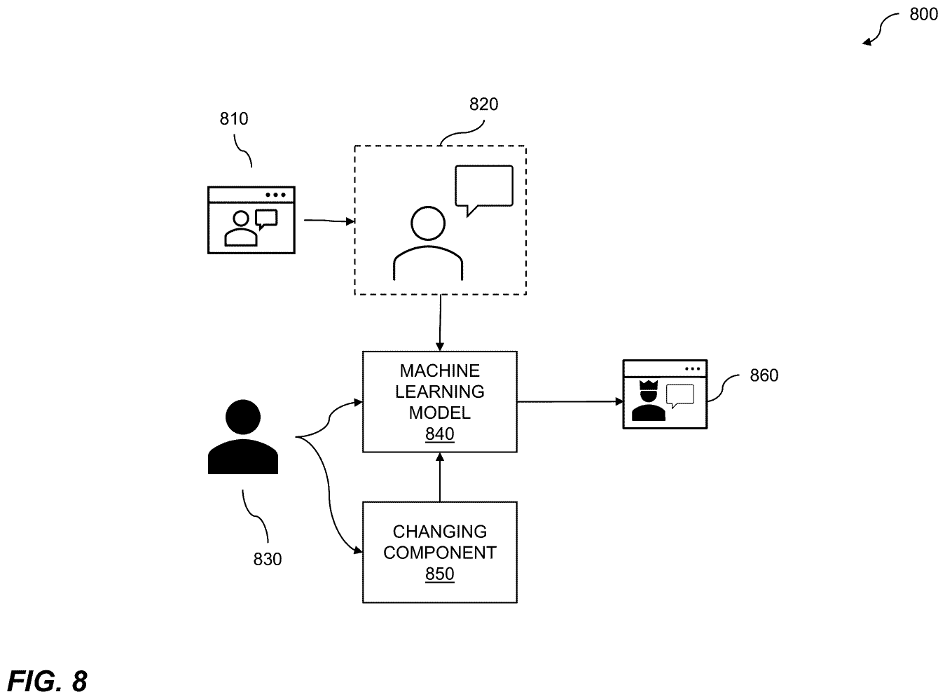

FIG. 8 is an infographic for changing attributes of the second individual in a second short-form video. During the creation of a second short-form video, attributes of the second individual's performance can be changed and applied to the second individual. The changes to the second individual's attributes can include one or more gestures, articles of clothing, facial expressions, accessories, background images, and one or more products for sale.

The infographic 800 includes a short-form video 810 that includes a performance by a first individual. In embodiments, the first individual performance can be delivered by a human or generated by artificial intelligence. The infographic 800 includes isolating the performance of the first individual 820 in the short-form video. In embodiments, artificial intelligence (AI) algorithms are used to detect the subject in the foreground of the video, mask the foreground image, and remove the background elements. The result is that only the image of the first individual remains; the performance of the first individual has been isolated from the background of the short-form video.

The infographic 800 includes retrieving an image that includes a representation of a second individual 830. In embodiments, more than one image can be included for the second individual 830. The images can be captured from still photographs or videos. The infographic 800 includes extracting information on the second individual 830 from the retrieved images. As stated above and throughout, AI algorithms can be used to separate an individual in the foreground of an image from the remainder of the image. The extracted images of the second individual can be used by a machine learning model 840 to generate a 3D model of the second individual's head, face, and in some implementations, upper body. The image analysis done by the machine learning model 840 allows attributes and/or components 850 of the second individual to be isolated and altered as desired.

The infographic 800 includes changing components 850 of the second individual 830 using the machine learning model 840. In embodiments, images of clothing, accessories, background images, products for sale, etc., can be extracted from still photographs, scanners, or videos and can be used to generate 3D models that can be stored and used as input to machine learning models 840. Gestures and facial expressions can also be isolated and analyzed to generate input to machine learning models 840. The clothing, accessories, background images, products for sale, gestures, and facial expressions can be stored as a set of change components 850 that can be added to the 3D model of the second individual 830 and used to generate a second short-form video.

The infographic 800 includes creating a second short-form video 860 combining the isolated performance of the first individual 820 with the images of the second individual 830. In embodiments, the performance of the first individual is replaced by generating neural network data replicas within a machine learning model 840. The first neural network analyzes and learns to encode and decode the first individual's performance in the short-form video. The second neural network analyzes and learns to encode and decode the second individual from a set of extracted images. Once both neural networks are built, the encoder for the second individual is combined with the decoder for the first individual. As each frame is processed, the various components, including clothing, accessories, background images, products for sale, gestures, and facial expressions, can be added to the machine learning model using the neural network images from the second individual. The resulting second short-form video 860 can be generated by the machine learning model 840 and recorded so that the performance of the first individual 820 and the changed components 850 of the second individual 830, including actions, gestures, expressions, clothing, and accessories, all appear to be performed or worn by the second individual.

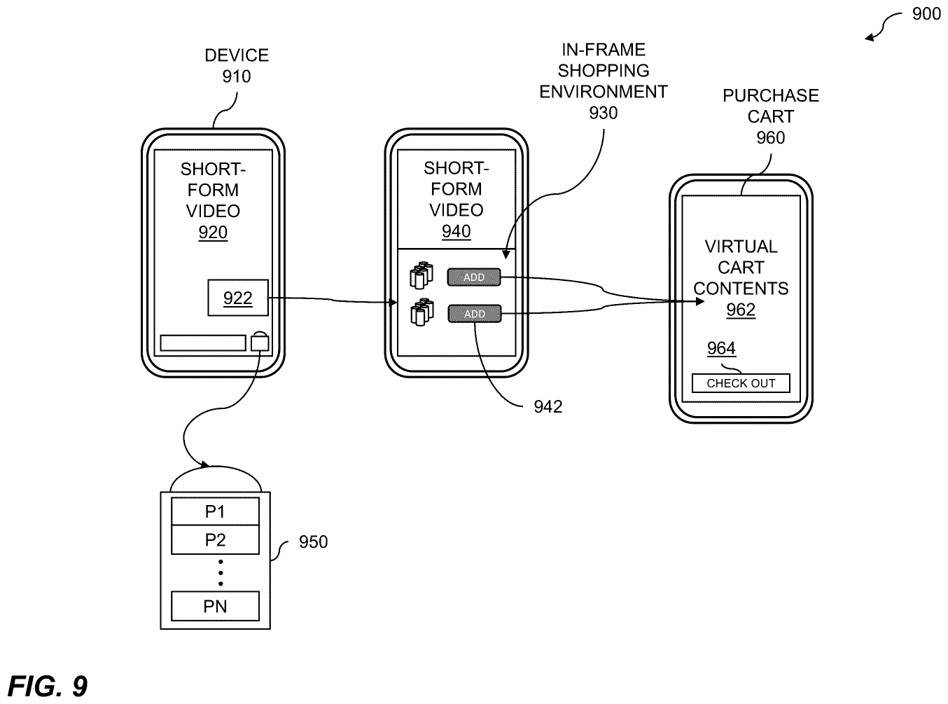

FIG. 9 shows an ecommerce purchase implementation within a short-form video environment. As described above and throughout, a short-form video can be used as the basis of a livestream event or replay. The livestream can highlight one or more products available for purchase during the livestream event. An ecommerce purchase can be enabled during the livestream event using an in-frame shopping environment. The in-frame shopping environment can allow CTV viewers and participants of the livestream event to buy products and services during the livestream event. The livestream event can include an on-screen product card that can be viewed on a CTV device and a mobile device. The in-frame shopping environment or window can also include a virtual purchase cart that can be used by viewers as the short-form video livestream event plays.

The implementation 900 includes a device 910 displaying a short-form video 920 as part of a livestream event. In embodiments, the livestream short-form video 920 can be viewed in real time or replayed at a later time. In some embodiments, the livestream short-form video can be hosted by a social network. The device 910 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream short-form video 920 on the device 910 can be accomplished using a browser or another application running on the device.

The implementation 900 includes generating and revealing a product card 922 on the device 910. In embodiments, the product card represents at least one product available for purchase while the livestream short-form video plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. When the product card is invoked, an in-frame shopping environment 930 is rendered over a portion of the video while the video continues to play. This rendering enables an ecommerce purchase 942 by a user while preserving a continuous video playback session. In other words, the user is not redirected to another site or portal that causes the video playback to stop. Thus, users are able to initiate and complete a purchase completely inside of the video playback user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The implementation 900 includes rendering an in-frame shopping environment 930 enabling a purchase of the at least one product for sale by the viewer, wherein the ecommerce purchase is accomplished within the livestream short-form video window 940. The enabling can include revealing a virtual purchase cart 960 that supports checkout 964 of virtual cart contents 962, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 950 are purchased via product cards during the playback of a short-form video, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

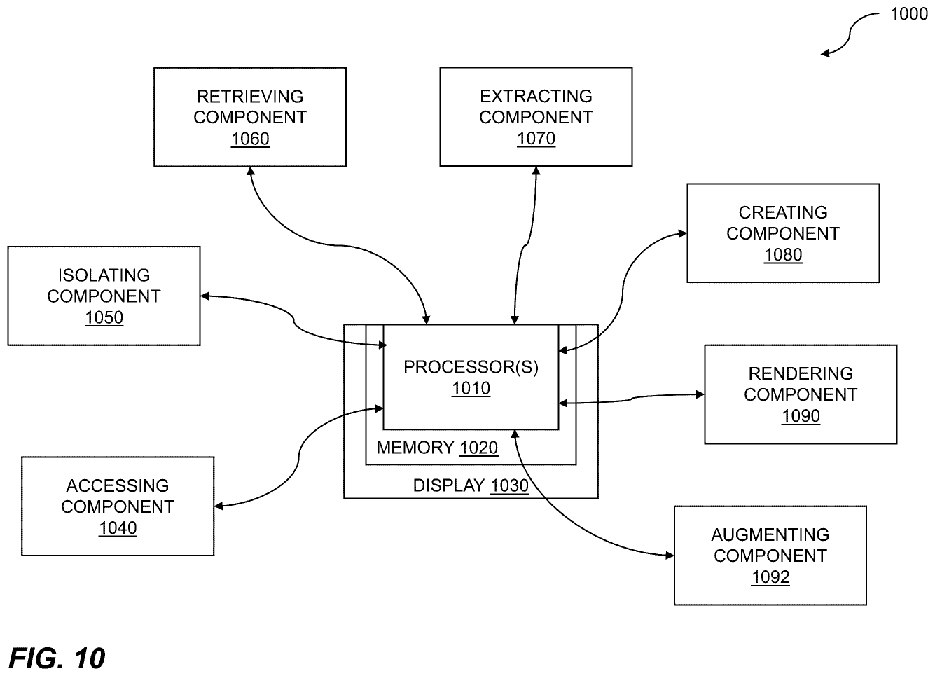

FIG. 10 is a system diagram for augmented performance replacement in a short-form video. The system 1000 can include one or more processors 1010 coupled to a memory 1020 which stores instructions. The system 1000 can include a display 1030 coupled to the one or more processors 1010 for displaying data, video streams, videos, highlighted products, product information, product cards, virtual purchase cart contents, chats, polls, webpages, intermediate steps, instructions, and so on. In embodiments, one or more processors 1010 are coupled to the memory 1020 where the one or more processors, when executing the instructions which are stored, are configured to: access a short-form video, wherein the short-form video includes a performance by a first individual; isolate, using one or more processors, the performance by the first individual from within the short-form video; retrieve an image, wherein the image includes a representation of a second individual; extract information on the second individual from the image; create a second short-form video by replacing the performance by the first individual, that was isolated, with the second individual, wherein the replacing is accomplished by machine learning; render the second short-form video; and augment the second short-form video, wherein the augmenting is based on viewer interactions, and wherein the augmenting occurs dynamically.

The system 1000 includes an accessing component 1040. The accessing component 1040 can include functions and instructions for accessing a short-form video, wherein the short-form video includes a performance by a first individual. In embodiments, the first individual performance can be delivered by a human or generated by artificial intelligence. In some embodiments, the short-form video can be a livestream event or a livestream playback. The short-form video can highlight one or more products for sale.

The system 1000 includes an isolating component 1050. The isolating component 1050 can include functions and instructions for isolating, using one or more processors 1010, the performance by the first individual within the short-form video. In embodiments, artificial intelligence (AI) algorithms are used to detect the subject in the foreground of the video, mask the foreground image, and remove the background elements. In some embodiments, video data from the short-form video is synchronized with depth data captured by a depth sensor camera used along with the short-form video camera. A depth sensor camera, also known as a Time of Flight or ToF camera, uses pulses of laser light to create a three-dimensional map of an image, such as an individual recording a video of him- or herself. The map can be generated in real time and used to apply various effects to images and videos. The rate at which the depth sensor camera produces the three-dimensional map must be synchronized to the frame rate used by the first video camera. The video content can be used to detect the presence of an individual (or a portion thereof), or the face of an individual in the video. Face detection can be accomplished using artificial-intelligence-based technology to locate human faces in digital images. Once AI algorithms detect a face in a digital image, additional datasets can be used to compare facial features in order to match a face located in video image with a previously stored faceprint and complete the recognition of a particular individual. Data from a depth sensor camera can be used to determine the distance between the short-form video camera and the face of the first individual. The first depth can be combined with a predetermined cutoff depth to set the maximum distance from the first camera in order to generate a binary mask. A binary mask is a digital image consisting of zero and non-zero values. In some embodiments, a binary mask can be used to filter out all digital pixel data that is determined to come from objects that are either closer or farther away from the camera than the first depth or cutoff depth. A predetermined cutoff depth can be used in combination with the first depth distance to create a binary mask of the portion of the individual recording the video. The result is that only the image of the first individual remains; the performance of the first individual has been isolated from the background of the short-form video.

The system 1000 includes a retrieving component 1060. The retrieving component 1060 can include functions and instructions for retrieving an image, wherein the image includes a representation of a second individual. In embodiments, the image can include multiple views of the second individual. The images can be captured from still photographs or videos.

The system 1000 includes an extracting component 1070. The extracting component 1070 can include functions and instructions for extracting information on the second individual from the one or more images. In embodiments, the image can include multiple views of the second individual. The images can be captured from still photographs or videos. AI algorithms can be used to separate an individual in the foreground of an image from the remainder of the image. The extracted images of the second individual can be used to generate a 3D model of the second individual's head, face, and in some implementations, upper body. Specific details of the second individual can be identified and used to enhance the performance of the second short-form video detailed in later steps. Details such as gestures, articles of clothing, facial expressions, accessories, background images, and products for sale can be isolated and extracted. AI and machine learning algorithms are employed to locate minute changes in image frames of short-form videos of the second individual, group and categorize the changes, and record them for use in performances. The same detailed analysis and extraction can be used with the performance of the first individual. This allows attributes of the first individual's performance to be applied to the second individual's performance in the second short-form video.

The system 1000 can include a creating component 1080. The creating component 1080 can include functions and instructions for creating a second short-form video by replacing the performance of the first individual, that was isolated, with the second individual, wherein the replacing is accomplished by machine learning. In embodiments, the attributes of the first individual's performance can be isolated and applied to the second individual. The first individual's attributes can include one or more gestures, articles of clothing, facial expressions, accessories, and the background of the first individual short-form video. Machine learning algorithms such as convolutional neural networks (CNNs) are used to identify designs within images such as lines, gradients, circles, eyes, and faces. The images are divided into multiple layers by using filters to separate groups of pixels. Variations within the layers are measured and combined or convolved to form a feature map. As the data is pooled and various weights are applied, human faces and features can be identified with a very low error rate. Replacing the first individual in the short-form video with the second individual is accomplished by generating neural network data models as part of the machine learning. The first neural network analyzes and learns to encode and decode the first individual's performance in the short-form video. The second neural network analyzes and learns to encode and decode the second individual from a set of extracted images. Once both neural networks are built, the encoder for the second individual is combined with the decoder for the first individual. As each frame is processed, the gestures, facial features, lighting, and movements of the first individual are decoded and encoded back into images using details from the second individual. In some embodiments, attributes of the second individual can be changed as part of the creation of the second short-form video. The attributes of the second individual can include one or more gestures, articles of clothing, facial expressions, accessories, background images, or products for sale. In some embodiments, the resulting images are then analyzed using a generative adversarial network (GAN) which compares the “new” image to recorded images of the second individual. The GAN step will reject inaccurate images, which causes another round of decoding and encoding until a sufficiently accurate image of the second individual is obtained.

The system 1000 can include a rendering component 1090. The rendering component 1090 can include functions and instructions for rendering the second short-form video. In embodiments, the second short-form video can be rendered for use in a livestream event or replay. As the machine learning creating process combines the first individual performance with the 3D model of the second individual, the resulting second short-form video can be rendered to viewers so that the actions, gestures, expressions, and appearance of the first individual appear to be performed by the second individual. In some embodiments, the rendering of the second short-form video can be accomplished in real time as part of a livestream event. In some embodiments, the second short-form video can be rendered and recorded for later use as a livestream replay or other replay purposes.

In some embodiments, the rendering component 1090 can render a representation of a product for sale in an on-screen product card. In embodiments, the rendering of a product card can be accomplished, using one or more processors 1010, by the livestream host within an ecommerce purchase window on the viewer's device. The rendering of the product card can include inserting a representation of a product or service for sale into the on-screen product card. A product card is a graphical element such as an icon, thumbnail picture, thumbnail video, symbol, or other suitable element that is displayed in front of the video. When the product card is invoked, an additional on-screen shopping window is rendered over a portion of the livestream video while the video continues to play. This rendering enables a viewer to view purchase information about a product/service while preserving a continuous video playback session.

The rendering component 1090 can be used to render a virtual purchase cart. In embodiments, the virtual purchase cart can appear as an icon, a pictogram, a representation of a purchase cart, and so on. The virtual purchase cart can appear as a cart, a basket, a bag, a tote, a sack, and the like. Using a mobile or other CTV device, such as a smart TV; a television connected to the internet via a cable box, TV stick, or game console; pad; tablet; laptop; or desktop computer, etc.; the viewer can click on the product or on the virtual purchase cart to add the product to the purchase cart. The viewer can click again on the virtual purchase cart to open the cart to display cart contents. The viewer can save the cart, edit the contents of the cart, delete items in the cart, etc. In some embodiments, the virtual purchase cart rendered to the viewer can cover a portion of the livestream window. The portion of the livestream window can range from a small portion to substantially all of the livestream window. However much of the livestream window is covered by the virtual purchase cart, the livestream event continues to play while the viewer is interacting with the virtual purchase cart.

The system 1000 can include an augmenting component 1092. The augmenting component 1092 can include functions and instructions for augmenting the second short-form video, wherein the augmenting is based on viewer interactions, and wherein the augmenting occurs dynamically. The augmenting further comprises switching audio content in the second short-form video with additional audio content, wherein the additional audio content matches the voice of the second individual. The augmenting further comprises adding additional audio content to the second short-form video, wherein the additional audio content matches the voice of the second individual. In some embodiments, the augmenting is controlled by a human operator or an AI computer model operator. The additional audio content can be based on viewer comments received while the second short-form video is viewed. The viewer comments can include responses to live polls or surveys; general questions and answers from viewers; or questions and answers based on products for sale during a livestream event. In some embodiments, the audio content is selected from a library of responses to viewers of other short-form videos. The audio content can include a shoutout to a viewer. In some embodiments, the shoutout can be in response to a donation, purchase, or subscription sign up by a viewer. The audio content can highlight products for sale during a livestream event, including special offers, coupons, or discounts available as the livestream short-form video plays. The augmenting component 1092 further comprises including additional video content to the second short-form video, wherein the additional video content comprises an additional performance by the first individual, wherein the second individual replaces the first individual.

The system 1000 can include a computer program product embodied in a non-transitory computer readable medium for video processing, the computer program product comprising code which causes one or more processors to perform operations of: accessing a short-form video, wherein the short-form video includes a performance by a first individual; isolating, using one or more processors, the performance by the first individual from within the short-form video; retrieving an image, wherein the image includes a representation of a second individual; extracting information on the second individual from the image; creating a second short-form video by replacing the performance by the first individual, that was isolated, with the second individual, wherein the replacing is accomplished by machine learning; rendering the second short-form video; and augmenting the second short-form video, wherein the augmenting is based on viewer interactions, and wherein the augmenting occurs dynamically.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products, and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing a short-form video, wherein the short-form video includes a performance by a first individual;
isolating, using one or more processors, the performance by the first individual from within the short-form video;
retrieving an image, wherein the image includes a representation of a second individual;
extracting information on the second individual from the image;
creating a second short-form video by replacing the performance by the first individual, that was isolated, with the second individual, wherein the replacing is accomplished by machine learning;
rendering the second short-form video; and
augmenting the second short-form video, wherein the augmenting is based on viewer interactions, and wherein the augmenting occurs dynamically.

2. The method of claim 1 wherein the augmenting further comprises switching audio content in the second short-form video with additional audio content, wherein the additional audio content matches a voice of the second individual.

3. The method of claim 1 wherein the augmenting further comprises adding additional audio content to the second short-form video, wherein the additional audio content matches a voice of the second individual.

4. The method of claim 3 wherein the augmenting is controlled by a human operator.

5. The method of claim 3 wherein the augmenting further comprises including additional video content to the second short-form video.

6. The method of claim 5 wherein the additional video content comprises an additional performance by the first individual, wherein the first individual is replaced by the second individual.

7. The method of claim 3 wherein the additional audio content is based on comments received while the second short-form video is viewed.

8. The method of claim 7 wherein the audio content is selected from a library of responses to viewers of other short-form videos.

9. The method of claim 3 wherein the augmenting includes questions and answers from viewers.

10. The method of claim 9 wherein the questions and answers are based on a product for sale.

11. The method of claim 3 wherein the augmenting includes highlighting a special offer.

12. The method of claim 3 wherein the augmenting includes a shoutout to a viewer.

13. The method of claim 12 wherein the shoutout is in response to a donation, purchase, or subscription.

14. The method of claim 1 wherein the first individual is computer generated.

15. The method of claim 1 wherein the replacing further comprises determining attributes of the first individual.

16. The method of claim 15 further comprising applying the attributes of the first individual to the second individual.

17. The method of claim 1 wherein the replacing further comprises changing attributes of the second individual.

18. The method of claim 1 further comprising enabling an ecommerce purchase, within the second short-form video, of a product for sale.

19. The method of claim 18 wherein the ecommerce purchase includes a representation of the product in an on-screen product card.

20. The method of claim 18 wherein the enabling includes a virtual purchase cart.

21. The method of claim 20 wherein the second short-form video that was rendered displays the virtual purchase cart while the second short-form video plays.

22. The method of claim 18 wherein the performance includes highlighting of the product for sale for the viewer.

23. The method of claim 1 wherein the image includes multiple views of the second individual.

24. The method of claim 1 wherein the augmenting is used to train a machine learning model.

25. A computer program product embodied in a non-transitory computer readable medium for video processing, the computer program product comprising code which causes one or more processors to perform operations of:
accessing a short-form video, wherein the short-form video includes a performance by a first individual;
isolating the performance by the first individual from within the short-form video;
retrieving an image, wherein the image includes a representation of a second individual;
extracting information on the second individual from the image;
creating a second short-form video by replacing the performance by the first individual, that was isolated, with the second individual, wherein the replacing is accomplished by machine learning;
rendering the second short-form video; and
augmenting the second short-form video, wherein the augmenting is based on viewer interactions, and wherein the augmenting occurs dynamically.

26. A computer system for video processing comprising:
a memory which stores instructions;
one or more processors coupled to the memory, wherein the one or more processors, when executing the instructions which are stored, are configured to:
access a short-form video, wherein the short-form video includes a performance by a first individual;
isolate the performance by the first individual from within the short-form video;
retrieve an image, wherein the image includes a representation of a second individual;
extract information on the second individual from the image;
create a second short-form video by replacing the performance by the first individual, that was isolated, with the second individual, wherein the replacing is accomplished by machine learning;
render the second short-form video; and
augment the second short-form video, wherein augmenting is based on viewer interactions, and wherein the augmenting occurs dynamically.
